(19) United States
(12) Patent Application Publication
(10) Pub. No.: US 2025/0024518 A1
(43) Pub. Date: Jan. 16, 2025

(54) RANDOM ACCESS METHOD AND APPARATUS, DEVICE, STORAGE MEDIUM, AND PROGRAM PRODUCT

(71) Applicant: GUANGDONG OPPO MOBILE TELECOMMUNICATIONS CORP., LTD., Dongguan (CN)

(72) Inventor: Zuomin WU, Dongguan (CN)

(21) Appl. No.: 18/901,334

(22) Filed: Sep. 30, 2024

Related U.S. Application Data
(63) Continuation of application No. PCT/CN2022/090359, filed on Apr. 29, 2022.

(51) Int. Cl. H04W 74/0833; H04W 72/23

(52) U.S. Cl. CPC H04W 74/0833; H04W 72/23

(57) ABSTRACT

Embodiments of this application provide a random access method and apparatus, a device, a storage medium, and a program product. The method includes: transmitting, by a terminal device, a first PRACH to a network device by using a first PRACH occasion; and monitoring, by the terminal device, a first PDCCH by using a first RNTI, where the first PDCCH is used to schedule a PDSCH, and the PDSCH scheduled by the first PDCCH carries an RAR.

This application is a continuation of International Application No. PCT/CN2022/090359, filed on Apr. 29, 2022, the disclosure of which is hereby incorporated by reference in its entirety.

### TECHNICAL FIELD

This application relates to the field of mobile communications technologies, and in particular, to a random access method and apparatus, a device, a storage medium, and a program product.

### BACKGROUND

In a mobile communications technology, a terminal device needs to perform uplink synchronization with a network device, to obtain an uplink resource and a valid identity, in order to perform data transmission in a mobile communications network.

### SUMMARY

Based on this, embodiments of this application provide a random access method and apparatus, a device, a storage medium, and a program product.

According to a first aspect, an embodiment of this application provides a random access method, where the method includes:
transmitting, by a terminal device, a first PRACH to a network device by using a first PRACH occasion; and
monitoring, by the terminal device, a first PDCCH by using a first RNTI, where the first PDCCH is used to schedule a PDSCH, and the PDSCH scheduled by the first PDCCH carries an RAR.

According to a second aspect, an embodiment of this application provides a random access method, where the method includes:
performing, by a network device, detection on a first PRACH by using a first PRACH occasion; and
after the first PRACH is detected by the network device, transmitting, by the network device, a first PDCCH by using a first RNTI, where the first PDCCH is used to schedule a PDSCH, and the PDSCH scheduled by the first PDCCH carries an RAR.

According to a third aspect, an embodiment of this application provides a random access apparatus, where the apparatus includes:
a transmitting module, configured to transmit a first PRACH to a network device by using a first PRACH occasion; and
a monitoring module, configured to monitor a first PDCCH by using a first RNTI, where the first PDCCH is used to schedule a PDSCH, and the PDSCH scheduled by the first PDCCH carries an RAR.

According to a fourth aspect, an embodiment of this application provides a random access apparatus, where the apparatus includes:
a detection module, configured to perform detection on a first PRACH by using a first PRACH occasion; and
a transmitting module, configured to transmit a first PDCCH by using a first RNTI after the first PRACH is detected, where the first PDCCH is used to schedule a PDSCH, and the PDSCH scheduled by the first PDCCH carries an RAR.

According to a fifth aspect, an embodiment of this application provides a terminal device, including a processor and a memory, where the memory is configured to store a computer program, and the processor is configured to invoke and run the computer program stored in the memory to execute the method according to the first aspect.

According to a sixth aspect, an embodiment of this application provides a network device, including a processor and a memory, where the memory is configured to store a computer program, and the processor is configured to invoke and run the computer program stored in the memory to execute the method according to the second aspect.

According to a seventh aspect, an embodiment of this application provides a chip, including a processor configured to invoke a computer program from a memory and run the computer program, to cause a device on which the chip is installed to execute the method according to the first aspect.

According to an eighth aspect, an embodiment of this application provides a chip, including a processor configured to invoke a computer program from a memory and run the computer program, to cause a device on which the chip is installed to execute the method according to the second aspect.

According to a ninth aspect, an embodiment of this application provides a computer-readable storage medium, configured to store a computer program, where the computer program causes a computer to execute the method according to the first aspect.

According to a tenth aspect, an embodiment of this application provides a computer-readable storage medium, configured to store a computer program, where the computer program causes a computer to execute the method according to the second aspect.

According to an eleventh aspect, an embodiment of this application provides a computer program product, including computer program instructions, where the computer program instructions cause a computer to execute the method according to the first aspect.

According to a twelfth aspect, an embodiment of this application provides a computer program product, including computer program instructions, where the computer program instructions cause a computer to execute the method according to the second aspect.

According to a thirteenth aspect, an embodiment of this application provides a computer program, where the computer program causes a computer to execute the method according to the first aspect.

According to a fourteenth aspect, an embodiment of this application provides a computer program, where the computer program causes a computer to execute the method according to the second aspect.

### BRIEF DESCRIPTION OF DRAWINGS

FIG. 1 is a schematic architectural diagram of a communications system according to an embodiment.

FIG. 2 is a schematic architectural diagram of a communications system according to an embodiment.

FIG. 3 is a schematic architectural diagram of a communications system according to an embodiment.

FIG. 4 is a flowchart of a random access method according to an embodiment.

FIG. 5 is a flowchart of a random access method according to an embodiment.

FIG. 6 is a flowchart of a random access method according to an embodiment.

FIG. 7 is a schematic diagram of a PRACH format according to an embodiment.

FIG. 8 is a flowchart of a random access method according to an embodiment.

FIG. 9 is a block diagram of a random access apparatus according to an embodiment.

FIG. 10 is a block diagram of a random access apparatus according to an embodiment.

FIG. 11 is a block diagram of a random access apparatus according to an embodiment.

FIG. 12 is a block diagram of a communications device according to an embodiment.

FIG. 13 is a block diagram of a chip according to an embodiment.

FIG. 14 is a block diagram of a communications system according to an embodiment.

### DESCRIPTION OF EMBODIMENTS

In order to make objectives, technical solutions and advantages of this application clearer, the following further describes this application in detail with reference to accompanying drawings and embodiments. It should be understood that specific embodiments described herein are merely used to explain this application, rather than limiting this application.

A communications system related in embodiments of this application may include a Terrestrial Network (TN for short) or a Non Terrestrial Network (NTN for short). The NTN generally provides a communication service for a terminal device on the ground in a manner of satellite communication, and the NTN currently includes an NR-NTN and an IoT-NTN.

Network standards of related communications systems are not limited in embodiments of this application. For example, in embodiments of this application, the communications system may be a long-term evolution (LTE for short) system, an LTE frequency division duplex (FDD for short) system, an LTE time division duplex (TDD for short) system, a 5G communications system, a future communications system, or the like.

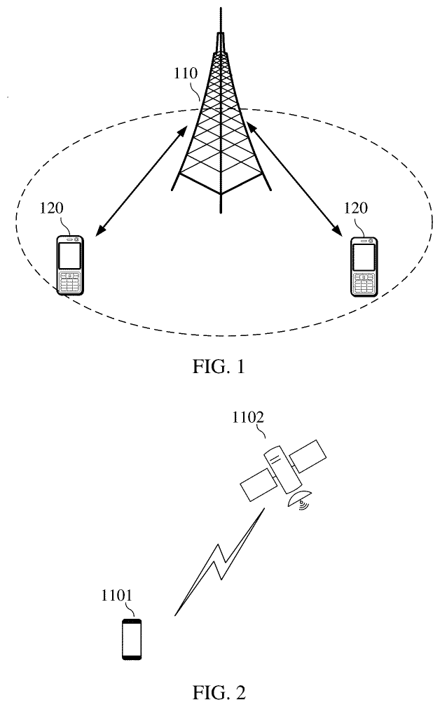

Referring to FIG. 1 to FIG. 3, FIG. 1 to FIG. 3 are schematic architectural diagrams of communications systems related in embodiments of this application.

As shown in FIG. 1, a communications system may include a network device 110, and the network device 110 may be a device that communicates with terminal devices 120. The network device 110 may provide communication coverage for a specific geographical area, and may communicate with a terminal device 120 located in the coverage area.

FIG. 1 exemplarily shows one network device 110 and two terminal devices 120. In some embodiments of this application, the communications system may include a plurality of network devices 110, and different quantities of terminal devices 120 may be located within coverage ranges of respective network devices 110. This is not limited in embodiments of this application.

As shown in FIG. 2, a communications system includes a terminal device 1101 and a satellite 1102, and wireless communication may be performed between the terminal device 1101 and the satellite 1102. A network formed by the terminal device 1101 and the satellite 1102 is an NTN. In an architecture of the communications system shown in FIG. 2, the satellite 1102 may have a function of a base station, and direct communication may be performed between the terminal device 1101 and the satellite 1102. In the architecture shown in FIG. 2, the satellite 1102 may be referred to as a network device. FIG. 2 exemplarily shows one network device 1102 and one terminal device 1101. In some embodiments of this application, the communications system may include a plurality of network devices 1102, and different quantities of terminal devices 1101 may be located within coverage ranges of respective network devices 1102. This is not limited in embodiments of this application.

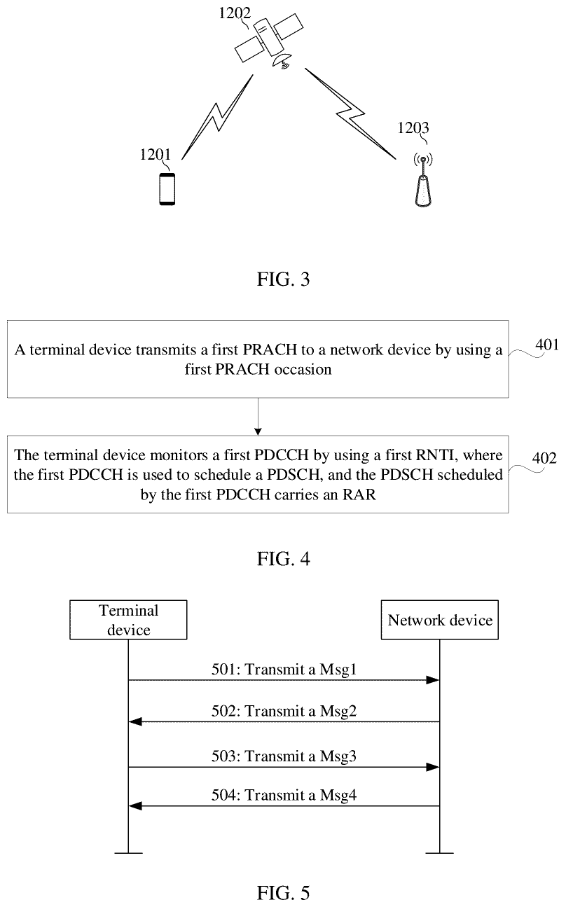

As shown in FIG. 3, a communications system includes a terminal device 1201, a satellite 1202, and a base station 1203. Wireless communication may be performed between the terminal device 1201 and the satellite 1202, and communication may be performed between the satellite 1202 and the base station 1203. A network formed by the terminal device 1201, the satellite 1202, and the base station 1203 is an NTN. In an architecture of the communications system shown in FIG. 3, the satellite 1202 does not have a function of a base station, and communication between the terminal device 1201 and the base station 1203 needs to be forwarded by the satellite 1202. Under this type of system architecture, the base station 1203 may be referred to as a network device. FIG. 3 exemplarily shows one network device 1203 and one terminal device 1201. In some embodiments of this application, the communications system may include a plurality of network devices 1203, and different quantities of terminal devices 1201 may be located within coverage ranges of respective network devices 1203. This is not limited in embodiments of this application.

The network device in the foregoing may be an evolved Node B (eNB or eNodeB) in an LTE system, or a radio controller in a cloud radio access network (CRAN). Alternatively, the network device may be a mobile switching center, a relay station, an access point, a vehicle-mounted device, a wearable device, a hub, a switch, a bridge, a router, a network-side device in a 5G network, a network device in a future communications system, or the like.

The “terminal device” in the foregoing includes but is not limited to a device that performs communication by using a wired line connection, for example, a public switched telephone network (PSTN), a digital subscriber line (DSL), a digital cable, a direct cable connection; and/or another data connection or network; and/or a wireless interface, for example, a cellular network, a wireless local area network (WLAN), a digital television network such as a DVB-H network, a satellite network, or an AM-FM broadcast transmitter; and/or an apparatus that is of another terminal device and that is configured to receive or transmit a communication signal; and/or an internet of things (IoT) device. A terminal device that is configured to communicate by using a wireless interface may be referred to as a “wireless communications terminal”, a “wireless terminal”, or a “mobile terminal”. Examples of the terminal device include but are not limited to a satellite or a cellular phone; a personal communications system (PCS) terminal that may combine a cellular radio phone with data processing, faxing, and a data communication capability; a PDA that may include a radio phone, a pager, internet/intranet access, a Web browser, a notebook, a calendar, and/or a global positioning system (GPS) receiver; and a conventional laptop and/or palmtop receiver or another electronic apparatus including a radio telephone transceiver. The terminal device may further refer to an access terminal, a user equipment (UE), a subscriber unit, a subscriber station, a mobile site, a mobile station, a remote station, a remote terminal, a mobile device, a user terminal, a terminal, a wireless communications device, a user agent, or a user apparatus. The access terminal may be a cellular phone, a cordless phone, a session initiation protocol (SIP) phone, a wireless local loop (WLL) station, a personal digital assistant (PDA), a handheld device having a wireless communication function, a computing device or another processing device connected to a wireless modem, a vehicle-mounted device, a wearable device, a terminal in a 5G network, a terminal in a future evolved PLMN, or the like.

In addition, the communications system in the foregoing may further include another network entity such as a network controller or a mobility management entity. This is not limited in embodiments of this application.

It should be noted that FIG. 1 to FIG. 3 are merely examples of systems to which this application applies. Certainly, the methods shown in embodiments of this application may also be applied to another system. It should be understood that the terms “system” and “network” may often be used interchangeably herein. In this specification, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects. It should be further understood that, the “indication” mentioned in embodiments of this application may be a direct indication or an indirect indication, or indicate an association. For example, if A indicates B, it may mean that A directly indicates B, for example, B may be obtained from A. Alternatively, it may mean that A indicates B indirectly, for example, A indicates C, and B may be obtained from C. Alternatively, it may mean that there is an association relationship between A and B. It should be further understood that the term “corresponding” mentioned in embodiments of this application may mean that there is a direct or indirect correspondence between two elements, or that there is an association between two elements, or that there is a relationship of “indicating” and “being indicated”, “configuring” and “being configured”, or the like. It should be further understood that the “predefined” or “predefined rule” mentioned in embodiments of this application may be implemented in a manner in which corresponding code, a table, or other related information used for indication is pre-stored in a device (for example, including a terminal device and a network device). A specific implementation is not limited in this application. For example, pre-defining may refer to being defined in a protocol. It should be further understood that in embodiments of this application, the “protocol” may refer to a standard protocol in the communication field, for example, may include an LTE protocol, an NR protocol, and a related protocol applied to a future communications system. This is not limited in this application.

Referring to FIG. 4, FIG. 4 is a flowchart of a random access method according to an embodiment of this application. As shown in FIG. 4, the random access method includes the following steps.

Step 401: A terminal device transmits a first PRACH to a network device by using a first PRACH (Physical Random Access Channel) occasion.

It should be noted that, regarding the PRACH transmitted by the terminal device to the network device as described in step 401, readers should understand that the PRACH herein may also be referred to as a random access preamble, a random access preamble code, or a random access preamble sequence.

In addition, the PRACH occasion (RO) described in step 401 refers to a resource used to transmit a PRACH (a random access preamble, a random access preamble code, or a random access preamble sequence) in a PRACH channel, and the PRACH occasion may also be referred to as a PRACH resource.

Step 402: The terminal device monitors a first PDCCH by using a first RNTI, where the first PDCCH is used to schedule a PDSCH, and the PDSCH scheduled by the first PDCCH carries an RAR.

After receiving the PRACH transmitted by the terminal device, the network device transmits an RAR (Random Access Response) to the terminal device. The RAR is carried in a PDSCH (Physical Downlink Shared CHannel), or, in other words, the RAR is transmitted by using the PDSCH. The PDSCH is scheduled by a PDCCH (Physical Downlink Control Channel), or, in other words, the PDSCH is scheduled by DCI (Downlink Control Information) carried on the PDCCH. A CRC (Cyclic Redundancy Check) of the DCI is scrambled by an RNTI (Radio Network Temporary Identifier).

The RNTI used to scramble the DCI is related to time-frequency information of the PRACH occasion. The terminal device may obtain the RNTI based on the PRACH occasion used to transmit the PRACH. In addition, the network device may obtain the RNTI based on a detected PRACH occasion that is used by the terminal device for transmitting the PRACH. In other words, the terminal device and the network device may obtain a same RNTI. In this way, the network device may scramble the CRC of the DCI based on the RNTI, and the terminal device may de-scramble the DCI based on the RNTI.

Based on the foregoing descriptions, in this embodiment of this application, after transmitting a first PRACH to a network device by using a first PRACH occasion, a terminal device may monitor a first PDCCH by using a first RNTI, where the first PDCCH is used to schedule a PDSCH, and the PDSCH scheduled by the first PDCCH carries an RAR. The first RNTI is determined based on time-frequency information of the first PRACH occasion.

In an optional embodiment of this application, the RAR carried in the PDSCH scheduled by the first PDCCH may correspond to the first PRACH, that is, a proper receiver of the RAR carried in the PDSCH scheduled by the first PDCCH may be the terminal device involved in step 401 and step 402 (for ease of distinguishing, the PDSCH in this case is referred to as a first PDSCH).

In another optional embodiment of this application, the RAR carried in the PDSCH scheduled by the first PDCCH does not correspond to the first PRACH, that is, a proper receiver of the RAR carried in the PDSCH scheduled by the first PDCCH is not the terminal device involved in step 401 and step 402, but is another terminal device.

It should be noted that the random access method provided in this embodiment of this application may be a type-1 random access procedure, or may be a type-2 random access procedure. The type-1 random access procedure is four-step random access, and the type-2 random access procedure is two-step random access. Correspondingly, the first PRACH occasion in the foregoing includes a PRACH occasion in a type-1 random access procedure or a PRACH occasion corresponding to a MsgA (message A) in a type-2 random access procedure. In addition, in a type-1 random access procedure, the first RNTI in the foregoing is an RA-RNTI (Random Access-RNTI), and in a type-2 random access procedure, the first RNTI in the foregoing is a MsgB-RNTI (message B-RNTI).

In addition, in a type-2 random access procedure, before the first PDCCH is monitored by using the first RNTI, the terminal device transmits a MsgA-PUSCH (message A-PUSCH) to the network device. The MsgA-PUSCH is determined based on an RA-RNTI, PUSCH is short for Physical Uplink Shared Channel.

In another optional embodiment of this application, in a type-2 random access procedure, step 401 may be replaced with: a terminal device transmits a MsgA to a network device, where a first PRACH corresponding to the MsgA is transmitted by using a first PRACH occasion, and a MsgA-PUSCH corresponding to the MsgA is determined based on an RA-RNTI. Step 402 may be replaced with: the terminal device monitors a first PDCCH according to a MsgB-RNTI, where the first PDCCH is used to schedule a PDSCH, and the PDSCH scheduled by the first PDCCH carries an RAR.

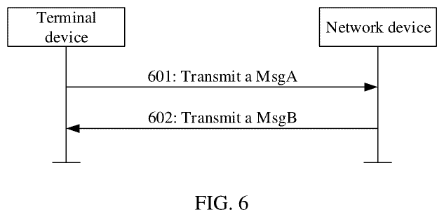

For ease of understanding, in the following, embodiments of this application separately describe the four-step random access and two-step random access. FIG. 5 is a flowchart of the four-step random access, and FIG. 6 is a flowchart of the two-step random access.

As shown in FIG. 5, the four-step random access includes step 501 to step 504.

Step 501: A terminal device transmits a PRACH (which may also be referred to as a message 1, that is, a Msg1, in the four-step random access) to a network device by using a PRACH occasion. This step corresponds to step 401 in the foregoing.

Step 502: After receiving the PRACH transmitted by the terminal device, the network device transmits, to the terminal device, an RAR (which may also be referred to as a message 2, that is, a Msg2, in the four-step random access). This step corresponds to step 402 in the foregoing.

An RAR is carried in a PDSCH, and the PDSCH is scheduled by a PDCCH. The PDCCH is scrambled by an RA-RNTI, or, in other words, the PDSCH is scheduled by DCI carried on the PDCCH. A CRC of the DCI carried on the PDCCH is scrambled by the RA-RNTI, and the RA-RNTI is determined based on time-frequency information of the PRACH occasion.

The RAR is used to notify the terminal device of a PUSCH resource allowed to be used to transmit a message 3, that is, a Msg3, and allocate a TC-RNTI (temporary-CRNTI) to the terminal device, and notify the terminal device of a TA (Timing Advance), where the CRNTI (Cell RNTI) is an identity allocated by the network device to the terminal device.

Step 503: After receiving the RAR, the terminal device transmits the message 3, that is, the Msg3, by using the PUSCH resource indicated by the RAR.

Step 504: The network device transmits, to the terminal device, a message 4, that is, a Msg4.

The Msg4 may include a contention resolution message. The Msg3 and the Msg4 are mainly used to resolve a problem of a terminal device conflict in a random access procedure. After receiving the Msg4, the terminal device feeds back ACK information corresponding to the Msg4 to the network device, thereby completing random access.

As shown in FIG. 6, the two-step random access includes step 601 and step 602.

Step 601: A terminal device transmits a message A (MsgA) to a network device through a PRACH channel and a PUSCH channel, where the MsgA includes a PRACH and a MsgA-PUSCH. A scrambling code of the MsgA-PUSCH is obtained through calculation by using an RA-RNTI. This step corresponds to step 401 in the foregoing.

Step 602: After receiving the MsgA, the network device transmits a message B (MsgB) to the terminal device, where the MsgB includes an RAR. This step corresponds to step 402 in the foregoing.

The RAR is carried in a PDSCH, or, in other words, the RAR is transmitted by using the PDSCH, the PDSCH is scheduled by a PDCCH, the PDCCH performs scrambling by using a MsgB-RNTI, or, in other words, the PDSCH is scheduled by DCI carried on the PDCCH, and a CRC in the DCI is scrambled by using the MsgB-RNTI.

After receiving the MsgB message, the terminal device feeds back ACK information corresponding to the MsgB message to the network device, thereby completing random access.

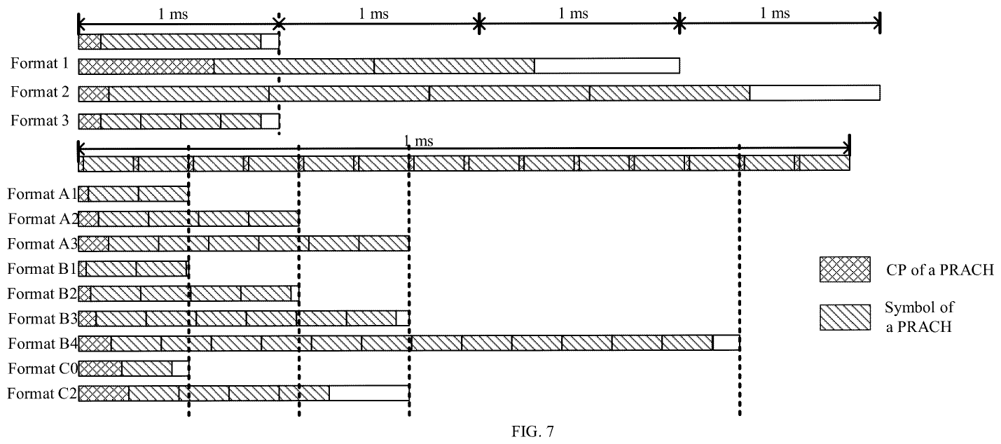

Because an NTN network has features such as a relatively large signal propagation latency and satellite mobility, a problem may occur in uplink coverage. To enhance uplink coverage for successful access of the terminal device to a network, in an evolved NTN network, an uplink coverage enhancement technology is introduced in a random access phase. In addition to existing PRACH formats 0, 1, 2, 3, A1, A2, A3, B1, B2, B3, B4, C0, and C2, the uplink coverage enhancement technology may introduce a new PRACH format or a new PRACH transmission method. A sequence length supported by the PRACH formats 0, 1, 2, and 3 is 839, sequence lengths supported by the PRACH formats A1, A2, A3, B1, B2, B3, B4, C0, and C2 include 139, 1151, and 571, a subcarrier spacing supported by the PRACH formats 0, 1, and 2 is 1.25 kHz, a subcarrier spacing supported by the PRACH format 3 is 5 kHz, and subcarrier spacings supported by the PRACH formats A1, A2, A3, B1, B2, B3, B4, C0, and C2 include 15 kHz, 30 kHz, 60 kHz, 120 kHz, 480 kHz, and 960 kHz. Referring to FIG. 7, FIG. 7 is a schematic diagram of PRACH formats 0, 1, 2, 3, A1, A2, A3, B1, B2, B3, B4, C0, and C2.

For a new PRACH format or a new PRACH transmission method, transmission duration may exceed a length of one system frame. Correspondingly, a length of a PRACH occasion used to transmit the new PRACH in time domain may also exceed the length of one system frame. Transmission durations for all existing PRACH formats are less than the length of one system frame. Correspondingly, a length of a PRACH occasion for transmitting an existing PRACH in time domain is also less than the length of one system frame. Therefore, existing RNTI is designed only for a PRACH occasion having a length less than the length of one system frame. Therefore, the existing RNTI is not applicable to an uplink coverage enhancement technology.

It should be noted that, although it is described above that the uplink coverage enhancement technology is introduced in the evolved NTN network, readers should understand that the uplink coverage enhancement technology is not limited to an NTN network. For example, the uplink coverage enhancement technology may also be introduced in a TN network.

It should be further noted that the random access method provided in steps 401 and 402 in the foregoing may be applied to an uplink coverage enhancement technology. In this case, the first PRACH is a PRACH in a new format, and transmission duration of the first PRACH exceeds the length of one system frame. Correspondingly, a length of the first PRACH occasion in time domain also exceeds the length of one system frame.

To resolve the foregoing problem that “an existing RNTI is not applicable to an uplink coverage enhancement technology”, embodiments of this application provide three methods. The following describes the three methods one by one in embodiments of this application.

First method: This method does not use a new RNTI, but uses an existing RNTI. However, using the existing RNTI may lead to a case in which different PRACH occasions in a PRACH configuration period correspond to a same RNTI. Therefore, a terminal device and a network device may have different understandings of the RNTI.

As described above, if different PRACH occasions correspond to a same RNTI, for the different PRACH occasions, when transmitting an RAR, the network device may use the same RNTI to scramble PDCCHs for scheduling PDSCHs, and terminal devices that respectively transmit PRACHs by using the different PRACH occasions may all de-scramble the PDCCHs, to receive, under scheduling of the PDCCHs, the PDSCHs that carry an RAR. In addition, each terminal device considers itself as the intended destination of the RAR transmitted by the network device, which causes an error.

For example, it is assumed that a terminal device 1 transmits a PRACH to the network device by using a PRACH occasion 1 and a PRACH preamble code 1, and a terminal device 2 transmits a PRACH to the network device by using a PRACH occasion 2 and the PRACH preamble code 1. By using an existing RNTI, the following case occurs: An RNTI corresponding to the PRACH occasion 1 is the same as an RNTI corresponding to the PRACH occasion 2. Assuming that both of the RNTIs are a target RNTI, when transmitting a PDSCH that carries an RAR to the terminal device 1, the network device scrambles, by using the target RNTI, a PDCCH for scheduling a PDSCH. The PDSCH includes an RAR corresponding to the PRACH preamble code 1. Both the terminal device 1 and the terminal device 2 may de-scramble a PDCCH based on the target RNTI, to receive, under scheduling of the PDCCH, a PDSCH that carries the RAR corresponding to the PRACH preamble code 1. In addition, the terminal device 1 considers that the PDSCH is transmitted by the network device to the terminal device 1 while the terminal device 2 considers that the PDSCH is transmitted by the network device to the terminal device 2. However, in fact, the PDSCH that carries the RAR corresponding to the PRACH preamble code 1 is transmitted by the network device only to the terminal device 1. Similarly, when transmitting the PDSCH that carries the RAR corresponding to the PRACH preamble code 1 to the terminal device 2, the network device scrambles a PDCCH for scheduling a PDSCH by using the target RNTI. Both the terminal device 1 and the terminal device 2 may de-scramble a PDCCH based on the target RNTI, to receive, under the scheduling of the PDCCH, the PDSCH that carries the RAR corresponding to the PRACH preamble code 1. In addition, the terminal device 1 considers that the PDSCH that carries the RAR corresponding to the PRACH preamble code 1 is transmitted by the network device to the terminal device 1 while the terminal device 2 considers that the PDSCH that carries the RAR corresponding to the PRACH preamble code 1 is transmitted by the network device to the terminal device 2. However, in fact, the PDSCH that carries the RAR corresponding to the PRACH preamble code 1 is transmitted by the network device only to the terminal device 2, which causes an error.

To avoid an error, in the first method, first indication information is introduced. The first indication information may indicate whether a terminal device is a proper receiver of a PDCCH, or the first indication information may indicate whether a terminal device is a proper receiver of a PDSCH. In this way, after a PDCCH is successfully de-scrambled, a terminal device may further determine, based on the first indication information, whether the PDCCH is a PDCCH transmitted by the network device to the terminal device. Alternatively, after receiving a PDSCH scheduled by a PDCCH that is successfully de-scrambled, a terminal device may further determine, based on the first indication information, whether the PDSCH is a PDSCH transmitted by the network device to the terminal device. Alternatively, after receiving an RAR in a PDSCH scheduled by a PDCCH, a terminal device may further determine, based on the first indication information, whether the RAR is an RAR transmitted by the network device to the terminal device.

For example, in the foregoing example, although both the terminal device 1 and the terminal device 2 may de-scramble a PDCCH based on the target RNTI, the terminal device 1 and the terminal device 2 may determine, based on an indication of the first indication information, whether a proper receiver of the PDCCH is the terminal device 1 or the terminal device 2. In this way, an error may be avoided. Alternatively, although both the terminal device 1 and the terminal device 2 may de-scramble a PDCCH based on the target RNTI, to receive, under scheduling of the PDCCH, a PDSCH that carries an RAR, the terminal device 1 and the terminal device 2 may determine, based on an indication of the first indication information, whether a proper receiver of the PDSCH is the terminal device 1 or the terminal device 2. In this way, an error may be avoided. Alternatively, although both the terminal device 1 and the terminal device 2 may receive an RAR in a PDSCH scheduled by a PDCCH, the terminal device 1 and the terminal device 2 may determine, based on an indication of the first indication information, whether a proper receiver of the RAR is the terminal device 1 or the terminal device 2. In this way, an error may be avoided.

Specifically, in the foregoing cases in step 401 and step 402, after the terminal device receives the first PDCCH or the PDSCH scheduled by the first PDCCH, the terminal device determines, based on the first indication information, whether the first PDCCH is a PDCCH for scheduling the first PDSCH; or, the terminal device determines, based on the first indication information, whether the PDSCH scheduled by the first PDCCH is the first PDSCH. As described above, the RAR carried in the first PDSCH is an RAR corresponding to the first PRACH.

In an optional embodiment of this application, the first indication information may be carried in the first PDCCH, or the first indication information may be carried in the PDSCH scheduled by the first PDCCH. Specifically, the first indication information may be carried in DCI carried on the first PDCCH, and/or, the first indication information may be carried in an RAR in the PDSCH scheduled by the first PDCCH.

In an optional embodiment of this application, the first indication information is used to indicate at least one of the following:
1. a system frame index corresponding to the first RNTI or a system frame index corresponding to the first PRACH occasion;
2. k least significant bits of a system frame index corresponding to the first RNTI or k least significant bits of a system frame index corresponding to the first PRACH occasion, where k is a positive integer greater than or equal to 1;
3. a system frame quantity value N corresponding to the first RNTI or a system frame quantity value N corresponding to the first PRACH occasion, where N is a positive integer greater than 1; or
4. a system frame index associated with the first RNTI in N system frames or a system frame index associated with the first PRACH occasion in N system frames.

The system frame index corresponding to the first RNTI or the system frame index corresponding to the first PRACH occasion refers to a system frame index corresponding to the first symbol of the first PRACH occasion, or, in other words, the system frame index corresponding to the first RNTI or the system frame index corresponding to the first PRACH occasion refers to an index of a system frame in which the first symbol of the first PRACH occasion is located, and values of the index may range from 0 to 1023. In a case in which a length of a PRACH occasion in time domain is greater than a length of one system frame, the first symbols of a plurality of PRACH occasions may be located in different system frames. Therefore, indication may be provided to the terminal device by using the system frame index corresponding to the first RNTI or the system frame index corresponding to the first PRACH occasion, so that the terminal device determines whether a proper receiver of the PDCCH and/or the PDSCH is the terminal device itself.

Considering that the system frame index corresponding to the first RNTI or the system frame index corresponding to the first PRACH occasion has a relatively large quantity of bits, to reduce an amount of transmitted data, optionally, the first indication information may indicate the k least significant bits of the system frame index corresponding to the first RNTI or the k least significant bits of the system frame index corresponding to the first PRACH occasion, where k is less than a quantity of bits of the system frame index corresponding to the first RNTI or a quantity of bits of the system frame index corresponding to the first PRACH occasion. In an optional embodiment of this application, k=ceil (log₂ (N)), where the ceil operator is an operator for obtaining a least integer greater than a variable, log₂ represents a logarithm with a base of 2, and N is the system frame quantity value corresponding to the first RNTI or the system frame quantity value corresponding to the first PRACH occasion or a configuration period of a PRACH occasion. For example, when a value of N is 4, k=2. In this case, the first indication information includes two bits, which are used to indicate two least significant bits of the system frame index corresponding to the first RNTI or two least significant bits of the system frame index corresponding to the first PRACH occasion. For another example, when the value of N is 6, k=3. In this case, the first indication information includes three bits, which are used to indicate three least significant bits of the system frame index corresponding to the first RNTI or three least significant bits of the system frame index corresponding to the first PRACH occasion. For still another example, when the value of N is 2, k=1. In this case, the first indication information includes one bit, which is used to indicate one least significant bit of the system frame index corresponding to the first RNTI or one least significant bit of the system frame index corresponding to the first PRACH occasion.

As described above, the first indication information may further indicate the system frame quantity value N corresponding to the first RNTI or the system frame quantity value N corresponding to the first PRACH occasion. In some cases, N may also be understood as a configuration period of a PRACH occasion, for example, a maximum configuration period corresponding to a PRACH resource configured by a system. In an optional embodiment of this application, the system frame quantity value N is determined based on at least one of the following:
1. a first length, where the first length is a maximum system-configurable length of a PRACH occasion in time domain; or
2. a second length, where the second length is a maximum system-configurable length of an RAR window.

An RAR window refers to a monitoring window of a PDCCH. To reduce power consumption, calculation complexity, and the like of a terminal device, an RAR window may be configured for the terminal device. In a process of receiving an RAR, the terminal device monitors a PDCCH only within the RAR window, but does not monitor a PDCCH outside the RAR window. In this way, duration of monitoring performed by the terminal device on a PDCCH may be effectively reduced, thereby achieving an effect of reducing the power consumption, calculation complexity, and the like of the terminal device.

In an optional embodiment of this application, the first length is greater than a length of one system frame, and/or, the second length is greater than a length of one system frame.

In an optional embodiment of this application, the system frame quantity value N corresponding to the first PRACH occasion is a minimum quantity of system frames having a total length greater than or equal to the first length. Alternatively, the system frame quantity value N corresponding to the first PRACH occasion is a minimum quantity of system frames having a total length greater than or equal to the second length. Alternatively, the system frame quantity value N corresponding to the first PRACH occasion is a minimum quantity of system frames having a total length greater than or equal to a third length, where the third length is the larger value of the first length and the second length.

For example, assuming that the first length is 16 milliseconds and a length of a single system frame is 10 milliseconds, a value of N is 2. Assuming that the second length is 40 milliseconds, the value of N is 4. Assuming that the first length is 16 milliseconds and the second length is 40 milliseconds, because the second length is greater than the first length, the value of N is 4.

In an optional embodiment of this application, the system frame quantity value N may be pre-configured by a network side, or the system frame quantity value N may be specified by a communication protocol.

In an uplink coverage enhancement technology, a length of N system frames may be considered as a configuration period of a PRACH occasion. One configuration period may include at least one PRACH occasion. Optionally, one PRACH occasion may span two or more configuration periods. It should be noted that “one configuration period may include at least one PRACH occasion” may be understood as: one configuration period may include the first symbol of at least one PRACH occasion.

It may be learned from the foregoing descriptions that a PRACH occasion may be distinguished from another based on a time domain position of the PRACH occasion in a configuration period, for example, a time domain position of a system frame including the first symbol of the PRACH occasion in a configuration period. Therefore, the first indication information may indicate a system frame index associated with the first RNTI in the N system frames or a system frame index associated with the first PRACH occasion in the N system frames, and values of the system frame index may range from 0 to N−1.

Second method: In this method, for a PRACH occasion with a greater length in time domain than one system frame, a new RNTI is introduced. Specifically, in the foregoing cases in step 401 and step 402, the first RNTI is the new RNTI described herein.

In an optional embodiment of this application, the first RNTI is determined based on at least one of the following:
1. a system frame index corresponding to the first PRACH occasion;
2. k least significant bits of a system frame index corresponding to the first PRACH occasion;
3. a system frame quantity value N corresponding to the first PRACH occasion; or
4. a system frame index associated with the first PRACH occasion in N system frames.

The system frame index corresponding to the first PRACH occasion, the k least significant bits of the system frame index corresponding to the first PRACH occasion, the system frame quantity value N corresponding to the first PRACH occasion, and the system frame index associated with the first PRACH occasion in the N system frames have been described in the foregoing. Details are not described herein in this embodiment of this application.

Further, in an optional embodiment of this application, the first RNTI is determined based on a result of a modulo operation performed with the system frame index corresponding to the first PRACH occasion and the system frame quantity value N corresponding to the first PRACH occasion, or the first RNTI is determined based on a result of a division operation performed with the system frame index corresponding to the first PRACH occasion and the system frame quantity value N corresponding to the first PRACH occasion, or the first RNTI is determined based on the system frame index associated with the first PRACH occasion in the N system frames.

In the second manner, an embodiment of this application provides specific formulas for calculating the first RNTI, where:

In a case in which the first RNTI is an RA-RNTI, the first RNTI may be calculated by using a first formula or a second formula.

The first formula includes:

$$RA - RNTI = 1 + s\_id + 14 \times t\_id + 14 \times 80 \times f\_id + 14 \times 80 \times 8 \times ul\_carrier \_id + 14 \times 80 \times 8 \times 2 \times ( \text{} SFN\_id mod N )$$

The second formula includes:

$$RA - RNTI = 1 + s\_id + 14 \times t\_id + 14 \times 80 \times f\_id + 14 \times 80 \times 8 \times ul\_carrier \_id + 14 \times 80 \times 8 \times 2 \times f ( \text{} SFN\_id / N )$$

s_id is an index of the first symbol of the first PRACH occasion, having a value range of 0≤s_id<14. t_id is an index of the first slot for the first PRACH occasion in a system frame, having a value range of 0≤t_id<80. A subcarrier spacing for determining t_id is determined based on a subcarrier spacing configuration μ. When a subcarrier spacing of the first PRACH is 1.25 kHz or 5 kHz, the subcarrier spacing is 15 kHz. Otherwise, when the subcarrier spacing of the first PRACH is 15 kHz, 30 kHz, 60 kHz, or 120 kHz, the subcarrier spacing is the same as the subcarrier spacing of the first PRACH. f_id is an index of the first PRACH occasion in frequency domain, having a value range of 0≤f_id<8. ul_carrier_id is an uplink carrier index corresponding to the first PRACH occasion, where 0 indicates a NUL (Normal uplink) carrier, and 1 indicates a SUL (Supplementary uplink) carrier. SFN_id is the system frame index corresponding to the first PRACH occasion, N is the system frame quantity value corresponding to the first PRACH occasion, mod is a modulo operator, (SFN_id mod N) represents the system frame index associated with the first PRACH occasion in the N system frames, and f is a floor operator or a ceil operator or a round operator, where the floor operator is an operator for obtaining a greatest integer less than a variable, the ceil operator is an operator for obtaining a least integer greater than a variable, and the round operator is an operator for obtaining an integer closest to a variable.

In a case in which the first RNTI is a MsgB-RNTI, the first RNTI may be calculated by using a third formula or a fourth formula.

The third formula includes:

$$MsgB - RNTI = 1 + s\_id + 14 \times t\_id + 14 \times 80 \times f\_id + 14 \times 80 \times 8 \times ul\_carrier \_id + 14 \times 80 \times 8 \times 2 \times ( SFN\_id mod N ) + 14 \times 80 \times 8 \times 2 \times N$$

The fourth formula includes:

$$MsgB - RNTI = 1 + s\_id + 14 \times t\_id + 14 \times 80 \times f\_id + 14 \times 80 \times 8 \times ul\_carrier \_id + 14 \times 80 \times 8 \times 2 \times f ( SFN\_id / N ) + 14 \times 80 \times 8 \times 2 \times N$$

s_id is an index of the first symbol of the first PRACH occasion, having a value range of 0≤s_id<14. t_id is an index of the first slot for the first PRACH occasion in a system frame, having a value range of 0≤t_id<80. A subcarrier spacing for determining t_id is determined based on a subcarrier spacing configuration u. When a subcarrier spacing of the first PRACH is 1.25 kHz or 5 kHz, the subcarrier spacing is 15 kHz. Otherwise, when the subcarrier spacing of the first PRACH is 15 kHz, 30 kHz, 60 kHz, or 120 kHz, the subcarrier spacing is the same as the subcarrier spacing of the first PRACH. f_id is an index of the first PRACH occasion in frequency domain, having a value range of 0≤f_id<8. ul_carrier_id is an uplink carrier index corresponding to the first PRACH occasion, where 0 indicates a NUL (Normal uplink) carrier, and 1 indicates a SUL (Supplementary uplink) carrier. SFN_id is the system frame index corresponding to the first PRACH occasion, N is the system frame quantity value corresponding to the first PRACH occasion, mod is a modulo operator, (SFN_id mod N) represents the system frame index associated with the first PRACH occasion in the N system frames, and f is a floor operator or a ceil operator or a round operator, where the floor operator is an operator for obtaining a greatest integer less than a variable, the ceil operator is an operator for obtaining a least integer greater than a variable, and the round operator is an operator for obtaining an integer closest to a variable.

Optionally, in a type-1 random access procedure, the new RNTI includes an RA-RNTI.

Optionally, in a type-2 random access procedure, the new RNTI includes a MsgB-RNTI and/or an RA-RNTI. For example, in a type-2 random access procedure, a MsgA-PUSCH is determined based on a new RA-RNTI, and the terminal device monitors the first PDCCH according to a new MsgB-RNTI.

Third method: In this method, the first PRACH occasion includes M existing PRACH occasions, where M is a positive integer greater than 1, and the existing PRACH occasions are used to transmit PRACHs in an existing format. Optionally, a length corresponding to the first PRACH occasion in time domain may be greater than a length of one system frame. Specifically, in the foregoing cases in step 401 and step 402, the first PRACH occasion includes M second PRACH occasions. As described above, the first PRACH occasion is used to transmit the first PRACH in a new format, the length of the first PRACH occasion in time domain may exceed a length of one system frame, and a second PRACH occasion is used to transmit a PRACH in an existing format. A PRACH format corresponding to a second PRACH occasion is at least one of the following formats: 0, 1, 2, 3, A1, A2, A3, B1, B2, B3, B4, C0, or C2. Certainly, the length of the first PRACH occasion in time domain may also be less than or equal to the length of one system frame. This is not limited in this application.

In the third method, the first RNTI is determined based on at least one second PRACH occasion in the M second PRACH occasions. In an optional embodiment of this application, the first RNTI is determined based on an RNTI corresponding to the at least one second PRACH occasion in the M second PRACH occasions. It should be noted that the RNTI corresponding to the second PRACH occasion may be an RNTI obtained based on an existing manner.

In an optional embodiment of this application, the first RNTI is an RNTI corresponding to the first second PRACH occasion in the M second PRACH occasions. Alternatively, the first RNTI is an RNTI corresponding to the last second PRACH occasion in the M second PRACH occasions.

It should be noted that, the case in which transmission duration for a new PRACH format or a new PRACH transmission method exceeds a length of one system frame is described merely as an example. The methods provided in this embodiment of this application may also be applied to a case in which transmission duration for a new PRACH format or a new PRACH transmission method does not exceed a length of one system frame. This is not limited in this application.

Referring to FIG. 8, FIG. 8 is a flowchart of a random access method according to an embodiment of this application. As shown in FIG. 8, the random access method includes the following steps.

Step 801: A network device performs detection on a first PRACH by using a first PRACH occasion.

Step 802: After the first PRACH is detected by the network device, the network device transmits a first PDCCH by using a first RNTI, where the first PDCCH is used to schedule a PDSCH, and the PDSCH scheduled by the first PDCCH carries an RAR.

The random access method shown in FIG. 8 is a step executed by a peer end (that is, a network device) involved in the random access method shown in FIG. 4. Therefore, the random access method shown in FIG. 8 is similar to the random access method shown in FIG. 4. For specific descriptions of the random access method shown in FIG. 8, refer to corresponding descriptions of FIG. 4. Details are not described herein in this embodiment of this application.

It should be noted that the random access method provided in this embodiment of this application may be a type-1 random access procedure, or may be a type-2 random access procedure. The type-1 random access procedure is four-step random access, and the type-2 random access procedure is two-step random access. Correspondingly, the first PRACH occasion includes a PRACH occasion in a type-1 random access procedure or a PRACH occasion corresponding to a MsgA in a type-2 random access procedure. In addition, in a type-1 random access procedure, the first RNTI is an RNTI-RNTI, and in a type-2 random access procedure, the first RNTI is a MsgB-RNTI.

In addition, in a type-2 random access procedure, before the network device transmits the first PDCCH by using the first RNTI, the network device receives a MsgA-PUSCH transmitted by a terminal device, where the MsgA-PUSCH is determined based on an RA-RNTI.

In another embodiment of this application, in a type-2 random access procedure, step 801 is replaced with: A network device receives a MsgA transmitted by a terminal device, where a first PRACH corresponding to the MsgA is transmitted by using a first PRACH occasion, and a MsgA-PUSCH corresponding to the MsgA is determined based on an RA-RNTI. Step 802 may be replaced with: The network device transmits a first PDCCH according to a MsgB-RNTI, where the first PDCCH is used to schedule a PDSCH, and the PDSCH scheduled by the first PDCCH carries an RAR.

For processes of four-step random access and two-step random access involved in the embodiment corresponding to FIG. 8, refer to the flowcharts shown in FIG. 5 and FIG. 6. Details are not described herein in this embodiment of this application.

Similar to the foregoing descriptions, in the random access method corresponding to FIG. 8, to resolve the problem that “an existing RNTI is not applicable to an uplink coverage enhancement technology”, an embodiment of this application provides three methods. The following describes the three methods one by one in this embodiment of this application.

First method: This method does not use a new RNTI, but uses an existing RNTI. However, using the existing RNTI may lead to a case in which different PRACH occasions in a PRACH configuration period correspond to a same RNTI. Therefore, a terminal device and a network device may have different understandings of the RNTI.

To avoid an error, in the first method, first indication information is introduced. The first indication information may indicate whether a terminal device is a proper receiver of a PDCCH, or the first indication information may indicate whether a terminal device is a proper receiver of a PDSCH. In this way, after a PDCCH is successfully de-scrambled, a terminal device may further determine, based on the first indication information, whether the PDCCH is a PDCCH transmitted by the network device to the terminal device. Alternatively, after receiving a PDSCH scheduled by a PDCCH that is successfully de-scrambled, a terminal device may further determine, based on the first indication information, whether the PDSCH is a PDSCH transmitted by the network device to the terminal device. Alternatively, after receiving an RAR in a PDSCH scheduled by a PDCCH, a terminal device may further determine, based on the first indication information, whether the RAR is an RAR transmitted by the network device to the terminal device.

Specifically, in the foregoing cases in step 801 and step 802, the network device transmits first indication information, where the first indication information is used to indicate whether the first PDCCH is a PDCCH for scheduling a first PDSCH, or the first indication information is used to indicate whether the PDSCH scheduled by the first PDCCH is a first PDSCH. An RAR carried in the first PDSCH is an RAR corresponding to the first PRACH.

In an optional embodiment of this application, the first indication information may be carried in the first PDCCH, or the first indication information may be carried in the PDSCH scheduled by the first PDCCH. Specifically, the first indication information may be carried in DCI carried on the first PDCCH, and/or, the first indication information may be carried in an RAR in the PDSCH scheduled by the first PDCCH.

In an optional embodiment of this application, the first indication information is used to indicate at least one of the following:
1. a system frame index corresponding to the first RNTI or a system frame index corresponding to the first PRACH occasion;
2. k least significant bits of a system frame index corresponding to the first RNTI or k least significant bits of a system frame index corresponding to the first PRACH occasion, where k is a positive integer greater than or equal to 1;
3. a system frame quantity value N corresponding to the first RNTI or a system frame quantity value N corresponding to the first PRACH occasion, where N is a positive integer greater than 1; or
4. a system frame index associated with the first RNTI in N system frames or a system frame index associated with the first PRACH occasion in N system frames.

The system frame index corresponding to the first RNTI or the system frame index corresponding to the first PRACH occasion refers to a system frame index corresponding to the first symbol of the first PRACH occasion, or, in other words, the system frame index corresponding to the first RNTI or the system frame index corresponding to the first PRACH occasion refers to an index of a system frame in which the first symbol of the first PRACH occasion is located, and values of the index may range from 0 to 1023.

Considering that the system frame index corresponding to the first RNTI or the system frame index corresponding to the first PRACH occasion has a relatively large quantity of bits, to reduce an amount of transmitted data, optionally, the first indication information may indicate the k least significant bits of the system frame index corresponding to the first RNTI or the k least significant bits of the system frame index corresponding to the first PRACH occasion, where k is less than a quantity of bits of the system frame index corresponding to the first RNTI or a quantity of bits of the system frame index corresponding to the first PRACH occasion. In an optional embodiment of this application, k=ceil (log₂ (N)), where the ceil operator is an operator for obtaining a least integer greater than a variable, and log₂ represents a logarithm with a base of 2. N is the system frame quantity value corresponding to the first RNTI or the system frame quantity value corresponding to the first PRACH occasion or a configuration period of a PRACH occasion. For example, when a value of N is 4, k=2. In this case, the first indication information includes two bits, which are used to indicate two least significant bits of the system frame index corresponding to the first RNTI or two least significant bits of the system frame index corresponding to the first PRACH occasion. For another example, when the value of N is 6, k=3. In this case, the first indication information includes three bits, which are used to indicate three least significant bits of the system frame index corresponding to the first RNTI or three least significant bits of the system frame index corresponding to the first PRACH occasion. For still another example, when the value of N is 2, k=1. In this case, the first indication information includes one bit, which is used to indicate one least significant bit of the system frame index corresponding to the first RNTI or one least significant bit of the system frame index corresponding to the first PRACH occasion.

As described above, the first indication information may further indicate the system frame quantity value N corresponding to the first RNTI or the system frame quantity value N corresponding to the first PRACH occasion. In some cases, N may also be understood as a configuration period of a PRACH occasion, for example, a maximum configuration period corresponding to a PRACH resource configured by a system. In an optional embodiment of this application, the system frame quantity value N is determined based on at least one of the following:
1. a first length, where the first length is a maximum system-configurable length of a PRACH occasion in time domain; or
2. a second length, where the second length is a maximum system-configurable length of an RAR window.

In an optional embodiment of this application, the first length is greater than a length of one system frame, and/or, the second length is greater than a length of one system frame.

In an optional embodiment of this application, the system frame quantity value N corresponding to the first PRACH occasion is a minimum quantity of system frames having a total length greater than or equal to the first length. Alternatively, the system frame quantity value N corresponding to the first PRACH occasion is a minimum quantity of system frames having a total length greater than or equal to the second length. Alternatively, the system frame quantity value N corresponding to the first PRACH occasion is a minimum quantity of system frames having a total length greater than or equal to a third length, where the third length is the larger value of the first length and the second length.

In an optional embodiment of this application, the system frame quantity value N may be pre-configured by a network side, or the system frame quantity value N may be specified by a communication protocol.

Second method: In this method, for a PRACH occasion with a greater length in time domain than one system frame, a new RNTI is introduced. Specifically, in the foregoing cases in step 801 and step 802, the first RNTI is the new RNTI described herein.

In an optional embodiment of this application, the first RNTI is determined based on at least one of the following:
1. a system frame index corresponding to the first PRACH occasion;
2. k least significant bits of a system frame index corresponding to the first PRACH occasion;
3. a system frame quantity value N corresponding to the first PRACH occasion; or
4. a system frame index associated with the first PRACH occasion in N system frames.

Further, in an optional embodiment of this application, the first RNTI is determined based on a result of a modulo operation performed with the system frame index corresponding to the first PRACH occasion and the system frame quantity value N corresponding to the first PRACH occasion, or the first RNTI is determined based on a result of a division operation performed with the system frame index corresponding to the first PRACH occasion and the system frame quantity value N corresponding to the first PRACH occasion, or the first RNTI is determined based on the system frame index associated with the first PRACH occasion in the N system frames.

In the second manner, an embodiment of this application provides specific formulas for calculating the first RNTI, where:

In a case in which the first RNTI is an RA-RNTI, the first RNTI may be calculated by using a first formula or a second formula. In a case in which the first RNTI is a MsgB-RNTI, the first RNTI may be calculated by using a third formula or a fourth formula.

The first formula, the second formula, the third formula, and the fourth formula are all described above. Details are not described herein in this embodiment of this application.

Optionally, in a type-1 random access procedure, the new RNTI includes an RA-RNTI.

Optionally, in a type-2 random access procedure, the new RNTI includes a MsgB-RNTI and/or an RA-RNTI. For example, in a type-2 random access procedure, a MsgA-PUSCH is determined based on a new RA-RNTI, and the network device transmits the first PDCCH according to a new MsgB-RNTI.

Third method: The first PRACH occasion includes M existing PRACH occasions, where M is a positive integer greater than 1, and the existing PRACH occasions are used to transmit PRACHs in an existing format. Optionally, a length corresponding to the first PRACH occasion in time domain may be greater than a length of one system frame. Specifically, in the foregoing cases in step 801 and step 802, the first PRACH occasion includes M second PRACH occasions. As described above, the first PRACH occasion is used to transmit the first PRACH in a new format, the length of the first PRACH occasion in time domain may exceed a length of one system frame, and a second PRACH occasion is used to transmit a PRACH in an existing format. A PRACH format corresponding to a second PRACH occasion is at least one of the following formats: 0, 1, 2, 3, A1, A2, A3, B1, B2, B3, B4, C0, or C2. Certainly, the length of the first PRACH occasion in time domain may also be less than or equal to the length of one system frame. This is not limited in this application.

In the third method, the first RNTI is determined based on at least one second PRACH occasion in the M second PRACH occasions. In an optional embodiment of this application, the first RNTI is determined based on an RNTI corresponding to the at least one second PRACH occasion in the M second PRACH occasions. It should be noted that the RNTI corresponding to the second PRACH occasion may be an RNTI obtained based on an existing manner.

In an optional embodiment of this application, the first RNTI is an RNTI corresponding to the first second PRACH occasion in the M second PRACH occasions. Alternatively, the first RNTI is an RNTI corresponding to the last second PRACH occasion in the M second PRACH occasions.

It should be noted that, the case in which transmission duration for a new PRACH format or a new PRACH transmission method exceeds a length of one system frame is described merely as an example. The methods provided in this embodiment of this application may also be applied to a case in which transmission duration for a new PRACH format or a new PRACH transmission method does not exceed a length of one system frame. This is not limited in this application.

It should be understood that, although steps in the flowcharts in FIG. 4 to FIG. 8 are sequentially shown according to an indication of the arrows, these steps are not necessarily sequentially executed according to a sequence indicated by the arrows. Unless expressly stated in this specification, these steps are not executed in an exact order, and these steps may be executed in another order. In addition, at least some of steps in FIG. 4 to FIG. 8 may include a plurality of sub-steps or stages. These sub-steps or stages are not necessarily executed at a same moment, but may be executed at different moments. An execution sequence of these sub-steps or stages is not necessarily performed sequentially, but may be executed in turns or alternately with at least some of other steps or sub-steps or stages of the other steps.

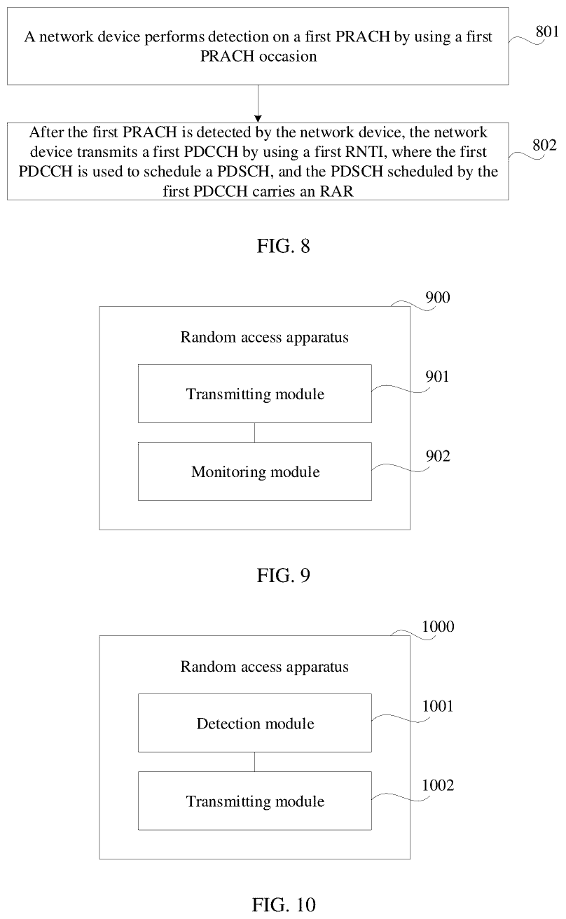

In one embodiment, as shown in FIG. 9, a random access apparatus 900 is provided, including a transmitting module 901 and a monitoring module 902.

The transmitting module 901 is configured to transmit a first PRACH to a network device by using a first PRACH occasion.

The monitoring module 902 is configured to monitor a first PDCCH by using a first RNTI, where the first PDCCH is used to schedule a PDSCH, and the PDSCH scheduled by the first PDCCH carries an RAR.

In an optional embodiment of this application, the monitoring module 902 is further configured to: after the first PDCCH or the PDSCH scheduled by the first PDCCH is received, determine, based on first indication information, whether the first PDCCH is a PDCCH for scheduling a first PDSCH, or determine, based on the first indication information, whether the PDSCH scheduled by the first PDCCH is the first PDSCH, where an RAR carried in the first PDSCH is an RAR corresponding to the first PRACH.

In an optional embodiment of this application, the first indication information is carried in the first PDCCH, or the first indication information is carried in the PDSCH scheduled by the first PDCCH.

In an optional embodiment of this application, the first indication information is used to indicate at least one of the following:
a system frame index corresponding to the first RNTI or a system frame index corresponding to the first PRACH occasion;
k least significant bits of a system frame index corresponding to the first RNTI or k least significant bits of a system frame index corresponding to the first PRACH occasion;
a system frame quantity value N corresponding to the first RNTI or a system frame quantity value N corresponding to the first PRACH occasion; or
a system frame index associated with the first RNTI in N system frames or a system frame index associated with the first PRACH occasion in N system frames;
where N is a positive integer greater than 1, and k is a positive integer greater than or equal to 1.

In an optional embodiment of this application, the first RNTI is determined based on at least one of the following:
a system frame index corresponding to the first PRACH occasion;
k least significant bits of a system frame index corresponding to the first PRACH occasion;
a system frame quantity value N corresponding to the first PRACH occasion; or
a system frame index associated with the first PRACH occasion in N system frames;
where N is a positive integer greater than 1, and k is a positive integer greater than or equal to 1.

In an optional embodiment of this application, the first RNTI is determined based on a result of a modulo operation performed with the system frame index corresponding to the first PRACH occasion and the system frame quantity value N corresponding to the first PRACH occasion; or
the first RNTI is determined based on a result of a division operation performed with the system frame index corresponding to the first PRACH occasion and the system frame quantity value N corresponding to the first PRACH occasion; or
the first RNTI is determined based on the system frame index associated with the first PRACH occasion in the N system frames.

In an optional embodiment of this application, the first RNTI is an RA-RNTI, and the RA-RNTI is calculated by using a first formula or a second formula.

The first formula includes:

$$RA - RNTI = 1 + s\_id + 14 \times t\_id + 14 \times 80 \times f\_id + 14 \times 80 \times 8 \times u1\_carrier \_id + 14 \times 80 \times 8 \times 2 \times ( SFN\_id mod N )$$

The second formula includes:

$$RA - RNTI = 1 + s\_id + 14 \times t\_id + 14 \times 80 \times f\_id + 14 \times 80 \times 8 \times u1\_carrier \_id + 14 \times 80 \times 8 \times 2 \times f ( SFN\_id / N )$$

s_id is an index of the first symbol of the first PRACH occasion, t_id is an index of the first slot for the first PRACH occasion in a system frame, f_id is an index of the first PRACH occasion in frequency domain, ul_carrier_id is an uplink carrier index corresponding to the first PRACH occasion, SFN_id is the system frame index corresponding to the first PRACH occasion, N is the system frame quantity value corresponding to the first PRACH occasion, mod is a modulo operator, (SFN_id mod N) represents the system frame index associated with the first PRACH occasion in the N system frames, and f is a floor operator or a ceil operator or a round operator, where the floor operator is an operator for obtaining a greatest integer less than a variable, the ceil operator is an operator for obtaining a least integer greater than a variable, and the round operator is an operator for obtaining an integer closest to a variable.

In an optional embodiment of this application, the RNTI is a MsgB-RNTI, and the MsgB-RNTI is calculated by using a third formula or a fourth formula.

The third formula includes:

$$MsgB - RNTI = 1 + s\_id + 14 \times t\_id + 14 \times 80 \times f\_id + 14 \times 80 \times 8 \times ul\_carrier \_id + 14 \times 80 \times 8 \times 2 \times ( SFN\_id mod N ) + 14 \times 80 \times 8 \times 2 \times N$$

The fourth formula includes:

$$MsgB - RNTI = 1 + s\_id + 14 \times t\_id + 14 \times 80 \times f\_id + 14 \times 80 \times 8 \times ul\_carrier \_id + 14 \times 80 \times 8 \times 2 \times f ( SFN\_id / N ) + 14 \times 80 \times 8 \times 2 \times N$$

s_id is an index of the first symbol of the first PRACH occasion, t_id is an index of the first slot for the first PRACH occasion in a system frame, f_id is an index of the first PRACH occasion in frequency domain, ul_carrier_id is an uplink carrier index corresponding to the first PRACH occasion, SFN_id is the system frame index corresponding to the first PRACH occasion, N is the system frame quantity value corresponding to the first PRACH occasion, mod is a modulo operator, (SFN_id mod N) represents the system frame index associated with the first PRACH occasion in the N system frames, and f is a floor operator or a ceil operator or a round operator, where the floor operator is an operator for obtaining a greatest integer less than a variable, the ceil operator is an operator for obtaining a least integer greater than a variable, and the round operator is an operator for obtaining an integer closest to a variable.

In an optional embodiment of this application, k=ceil (log₂ (N)), where the ceil operator is an operator for obtaining a least integer greater than a variable, and log₂ represents a logarithm with a base of 2.

In an optional embodiment of this application, the system frame index corresponding to the first PRACH occasion includes a system frame index corresponding to the first symbol of the first PRACH occasion.

In an optional embodiment of this application, the system frame quantity value N corresponding to the first PRACH occasion is determined based on at least one of the following:
a first length, where the first length is a maximum system-configurable length of a PRACH occasion in time domain; or
a second length, where the second length is a maximum system-configurable length of an RAR window.

In an optional embodiment of this application, the first length is greater than a length of one system frame, and/or, the second length is greater than a length of one system frame.

In an optional embodiment of this application, the system frame quantity value N corresponding to the first PRACH occasion is a minimum quantity of system frames having a total length greater than or equal to the first length; or
the system frame quantity value N corresponding to the first PRACH occasion is a minimum quantity of system frames having a total length greater than or equal to the second length; or
the system frame quantity value N corresponding to the first PRACH occasion is a minimum quantity of system frames having a total length greater than or equal to a third length, where the third length is the larger value of the first length and the second length.

In an optional embodiment of this application, the first PRACH occasion includes M second PRACH occasions, the first RNTI is determined based on at least one second PRACH occasion in the M second PRACH occasions, and M is a positive integer greater than 1.

In an optional embodiment of this application, the first RNTI is determined based on an RNTI corresponding to the at least one second PRACH occasion in the M second PRACH occasions.

In an optional embodiment of this application, the first RNTI is an RNTI corresponding to the first second PRACH occasion in the M second PRACH occasions; or
the first RNTI is an RNTI corresponding to the last second PRACH occasion in the M second PRACH occasions.

In an optional embodiment of this application, a PRACH format corresponding to the second PRACH occasion is at least one of the following formats: 0, 1, 2, 3, A1, A2, A3, B1, B2, B3, B4, C0, or C2.

In an optional embodiment of this application, the first PRACH occasion includes a PRACH occasion in a type-1 random access procedure, and the first RNTI includes an RA-RNTI.

In an optional embodiment of this application, the first PRACH occasion includes a PRACH occasion corresponding to a MsgA in a type-2 random access procedure, and the first RNTI includes a MsgB-RNTI.

In an optional embodiment of this application, the transmitting module 901 is further configured to: before the first PDCCH is monitored by using the first RNTI, transmit a MsgA-PUSCH to the network device, where the MsgA-PUSCH is determined based on an RA-RNTI.

An implementation principle and a technical effect of the random access apparatus provided in the foregoing embodiment are similar to those in the foregoing method embodiments, and are not described herein again.

In one embodiment, as shown in FIG. 10, a random access apparatus 1000 is provided. The random access apparatus 1000 includes a detection module 1001 and a transmitting module 1002.

The detection module 1001 is configured to perform detection on a first PRACH by using a first PRACH occasion.

The transmitting module 1002 is configured to transmit a first PDCCH by using a first RNTI after the first PRACH is detected, where the first PDCCH is used to schedule a PDSCH, and the PDSCH scheduled by the first PDCCH carries an RAR.

In an optional embodiment of this application, the transmitting module 1002 is further configured to transmit first indication information, where the first indication information is used to indicate whether the first PDCCH is a PDCCH for scheduling a first PDSCH, or the first indication information is used to indicate whether the PDSCH scheduled by the first PDCCH is the first PDSCH, where an RAR carried in the first PDSCH is an RAR corresponding to the first PRACH.

In an optional embodiment of this application, the first indication information is carried in the first PDCCH, or the first indication information is carried in the PDSCH scheduled by the first PDCCH.

In an optional embodiment of this application, the first indication information is used to indicate at least one of the following:
a system frame index corresponding to the first RNTI or a system frame index corresponding to the first PRACH occasion;
k least significant bits of a system frame index corresponding to the first RNTI or k least significant bits of a system frame index corresponding to the first PRACH occasion;
a system frame quantity value N corresponding to the first RNTI or a system frame quantity value N corresponding to the first PRACH occasion; or
a system frame index associated with the first RNTI in N system frames or a system frame index associated with the first PRACH occasion in N system frames;
where N is a positive integer greater than 1, and k is a positive integer greater than or equal to 1.

In an optional embodiment of this application, the first RNTI is determined based on at least one of the following:
a system frame index corresponding to the first PRACH occasion;
k least significant bits of a system frame index corresponding to the first PRACH occasion;
a system frame quantity value N corresponding to the first PRACH occasion; or
a system frame index associated with the first PRACH occasion in N system frames;
where N is a positive integer greater than 1, and k is a positive integer greater than or equal to 1.

In an optional embodiment of this application, the first RNTI is determined based on a result of a modulo operation performed with the system frame index corresponding to the first PRACH occasion and the system frame quantity value N corresponding to the first PRACH occasion; or
the first RNTI is determined based on a result of a division operation performed with the system frame index corresponding to the first PRACH occasion and the system frame quantity value N corresponding to the first PRACH occasion; or
the first RNTI is determined based on the system frame index associated with the first PRACH occasion in the N system frames.

In an optional embodiment of this application, the first RNTI is an RA-RNTI, and the RA-RNTI is calculated by using a first formula or a second formula.

The first formula includes:

$$RA - RNTI = 1 + s\_id + 14 \times t\_id + 14 \times 80 \times f\_id + 14 \times 80 \times 8 \times ul\_carrier \_id + 14 \times 80 \times 8 \times 2 \times ( SFN\_id mod N )$$

The second formula includes:

$$RA - RNTI = 1 + s\_id + 14 \times t\_id + 14 \times 80 \times f\_id + 14 \times 80 \times 8 \times ul\_carrier \_id + 14 \times 80 \times 8 \times 2 \times f ( SFN\_id / N )$$

s_id is an index of the first symbol of the first PRACH occasion, t_id is an index of the first slot for the first PRACH occasion in a system frame, f_id is an index of the first PRACH occasion in frequency domain, ul_carrier_id is an uplink carrier index corresponding to the first PRACH occasion, SFN_id is the system frame index corresponding to the first PRACH occasion, N is the system frame quantity value corresponding to the first PRACH occasion, mod is a modulo operator, (SFN_id mod N) represents the system frame index associated with the first PRACH occasion in the N system frames, and f is a floor operator or a ceil operator or a round operator, where the floor operator is an operator for obtaining a greatest integer less than a variable, the ceil operator is an operator for obtaining a least integer greater than a variable, and the round operator is an operator for obtaining an integer closest to a variable.

In an optional embodiment of this application, the first RNTI is a MsgB-RNTI, and the MsgB-RNTI is calculated by using a third formula or a fourth formula.

The third formula includes:

$$MsgB - RNTI = 1 + s\_id + 14 \times t\_id + 14 \times 80 \times f\_id + 14 \times 80 \times 8 \times ul\_carrier \_id + 14 \times 80 \times 8 \times 2 \times ( SFN\_id mod N ) + 14 \times 80 \times 8 \times 2 \times N$$

The fourth formula includes:

$$MsgB - RNTI = 1 + s\_id + 14 \times t\_id + 14 \times 80 \times f\_id + 14 \times 80 \times 8 \times ul\_carrier \_id + 14 \times 80 \times 8 \times 2 \times f ( SFN\_id / N ) + 14 \times 80 \times 8 \times 2 \times N$$

s_id is an index of the first symbol of the first PRACH occasion, t_id is an index of the first slot for the first PRACH occasion in a system frame, f_id is an index of the first PRACH occasion in frequency domain, ul_carrier_id is an uplink carrier index corresponding to the first PRACH occasion, SFN_id is the system frame index corresponding to the first PRACH occasion, N is the system frame quantity value corresponding to the first PRACH occasion, mod is a modulo operator, (SFN_id mod N) represents the system frame index associated with the first PRACH occasion in the N system frames, and f is a floor operator or a ceil operator or a round operator, where the floor operator is an operator for obtaining a greatest integer less than a variable, the ceil operator is an operator for obtaining a least integer greater than a variable, and the round operator is an operator for obtaining an integer closest to a variable.

In an optional embodiment of this application, k=ceil (log₂ (N)), where the ceil operator is an operator for obtaining a least integer greater than a variable, and log₂ represents a logarithm with a base of 2.

In an optional embodiment of this application, the system frame index corresponding to the first PRACH occasion includes a system frame index corresponding to the first symbol of the first PRACH occasion.

In an optional embodiment of this application, the system frame quantity value N corresponding to the first PRACH occasion is determined based on at least one of the following:
a first length, where the first length is a maximum system-configurable length of a PRACH occasion in time domain; or
a second length, where the second length is a maximum system-configurable length of an RAR window.

In an optional embodiment of this application, the first length is greater than a length of one system frame, and/or, the second length is greater than a length of one system frame.

In an optional embodiment of this application, the system frame quantity value N corresponding to the first PRACH occasion is a minimum quantity of system frames having a total length greater than or equal to the first length; or
the system frame quantity value N corresponding to the first PRACH occasion is a minimum quantity of system frames having a total length greater than or equal to the second length; or
the system frame quantity value N corresponding to the first PRACH occasion is a minimum quantity of system frames having a total length greater than or equal to a third length, where the third length is the larger value of the first length and the second length.

In an optional embodiment of this application, the first PRACH occasion includes M second PRACH occasions, the first RNTI is determined based on at least one second PRACH occasion in the M second PRACH occasions, and M is a positive integer greater than 1.

In an optional embodiment of this application, the first RNTI is determined based on an RNTI corresponding to the at least one second PRACH occasion in the M second PRACH occasions.

In an optional embodiment of this application, the first RNTI is an RNTI corresponding to the first second PRACH occasion in the M second PRACH occasions; or
the first RNTI is an RNTI corresponding to the last second PRACH occasion in the M second PRACH occasions.

In an optional embodiment of this application, a PRACH format corresponding to the second PRACH occasion is at least one of the following formats: 0, 1, 2, 3, A1, A2, A3, B1, B2, B3, B4, C0, or C2.

In an optional embodiment of this application, the first PRACH occasion includes a PRACH occasion in a type-1 random access procedure, and the first RNTI includes an RA-RNTI.

In an optional embodiment of this application, the first PRACH occasion includes a PRACH occasion corresponding to a message MsgA in a type-2 random access procedure, and the first RNTI includes a MsgB-RNTI.

Referring to FIG. 11, FIG. 11 shows another random access apparatus 1100. In addition to the modules included in the random access apparatus 1000, the random access apparatus 1100 further includes a receiving module 1003.

The receiving module 1003 is configured to: before a first PDCCH is transmitted by using a first RNTI, receive a MsgA-PUSCH transmitted by a network device, where the MsgA-PUSCH is determined based on an RA-RNTI.

An implementation principle and a technical effect of the random access apparatus provided in the foregoing embodiment are similar to those in the foregoing method embodiments, and are not described herein again.

For a specific limitation on the random access apparatus, refer to the foregoing limitation on a random access method. Details are not described herein again. All or some of the modules in the foregoing random access apparatus may be implemented by using software, hardware, and a combination thereof. The foregoing modules may be embedded in or independent of a processor in a communications device in a hardware form, or may be stored in a memory in the communications device in a software form, so that the processor invokes the foregoing modules to execute corresponding operations.

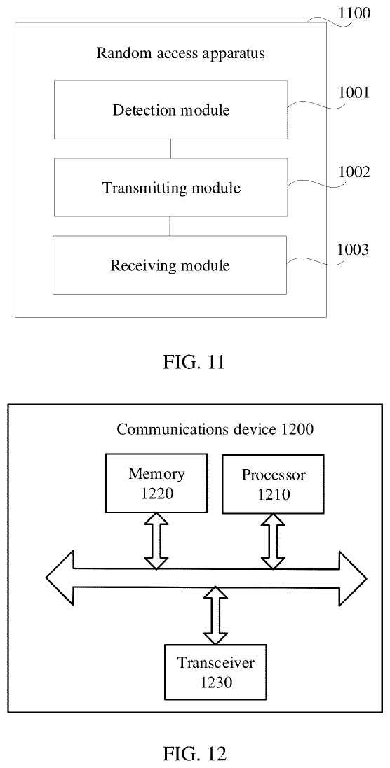

FIG. 12 is a schematic structural diagram of a communications device 1200 according to an embodiment of this application. The communications device may be a terminal device, or may be a network device. The communications device 1200 shown in FIG. 12 includes a processor 1210, and the processor 1210 may invoke a computer program from a memory and run the computer program, to implement a method in embodiments of this application.

Optionally, as shown in FIG. 12, the communications device 1200 may further include a memory 1220. The processor 1210 may invoke a computer program from the memory 1220 and run the computer program, to implement a method in embodiments of this application.

The memory 1220 may be a separate component independent of the processor 1210, or may be integrated into the processor 1210.

Optionally, as shown in FIG. 12, the communications device 1200 may further include a transceiver 1230. The processor 1210 may control the transceiver 1230 to communicate with another device, which may specifically include transmitting information or data to the another device, or receiving information or data transmitted by the another device.

The transceiver 1230 may include a transmitting set and a receiving set. The transceiver 1230 may further include an antenna, and a quantity of antennas may be one or more.

Optionally, the communications device 1200 may be specifically a network device in embodiments of this application, and the communications device 1200 may implement corresponding procedures implemented by the network device in methods in embodiments of this application. For brevity, details are not described herein again.

Optionally, the communications device 1200 may be specifically a terminal device in embodiments of this application, and the communications device 1200 may implement corresponding procedures implemented by the terminal device in methods in embodiments of this application. For brevity, details are not described herein again.

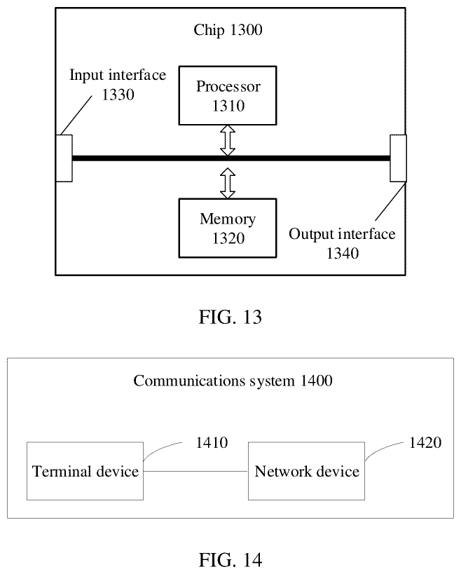

FIG. 13 is a schematic structural diagram of a chip according to an embodiment of this application. The chip 1300 shown in FIG. 13 includes a processor 1310, and the processor 1310 may invoke a computer program from a memory and run the computer program, to implement a method in embodiments of this application.

Optionally, as shown in FIG. 13, the chip 1300 may further include a memory 1320. The processor 1310 may invoke a computer program from the memory 1320 and run the computer program, to implement a method in embodiments of this application.

The memory 1320 may be a separate component independent of the processor 1310, or may be integrated into the processor 1310.

Optionally, the chip 1300 may further include an input interface 1330. The processor 1310 may control the input interface 1330 to communicate with another device or chip, which may specifically, include obtaining information or data transmitted by the another device or chip.

Optionally, the chip 1300 may further include an output interface 1340. The processor 1310 may control the output interface 1340 to communicate with another device or chip, which may specifically, include outputting information or data to the another device or chip.

Optionally, the chip may be applied to a network device in embodiments of this application, and the chip may implement corresponding procedures implemented by the network device in methods in embodiments of this application. For brevity, details are not described herein again.

Optionally, the chip may be applied to a terminal device in embodiments of this application, and the chip may implement corresponding procedures implemented by the terminal device in methods in embodiments of this application. For brevity, details are not described herein again.

It should be understood that the chip mentioned in this embodiment of this application may be referred to as a system-level chip, a system chip, a chip system, a system-on-chip, or the like.

FIG. 14 is a schematic block diagram of a communications system 1400 according to an embodiment of this application. As shown in FIG. 14, the communications system 1400 includes a terminal device 1410 and a network device 1420.

The terminal device 1410 may be configured to implement corresponding functions implemented by a terminal device in the foregoing methods, and the network device 1420 may be configured to implement corresponding functions implemented by a network device in the foregoing methods. For brevity, details are not described herein again.

It should be understood that, a processor in embodiments of this application may be an integrated circuit chip having a signal processing capability. In an implementation process, the steps in the foregoing method embodiments may be completed by using an integrated logic circuit of hardware in the processor or instructions in a software form. The processor may be a general-purpose processor, a digital signal processor (DSP), an application-specific integrated circuit (ASIC), a field-programmable gate array (FPGA) or another programmable logic device, a discrete gate or a transistor logic device, or a discrete hardware component. The processor may implement or execute the methods, steps, and logical block diagrams disclosed in embodiments of this application. The general-purpose processor may be a microprocessor, or the processor may be any conventional processor or the like. The steps of the methods disclosed with reference to embodiments of this application may be directly completed by a hardware decoding processor, or may be completed by a combination of hardware and software modules in a decoding processor. The software module may be located in a mature storage medium in the art, for example, a random access memory, a flash memory, a read-only memory, a programmable read-only memory, an erasable programmable memory, or a register. The storage medium is located in a memory. The processor reads information from the memory, and completes the steps of the foregoing methods in combination with hardware in the processor.

It may be understood that the memory in embodiments of this application may be a volatile memory or a non-volatile memory, or may include both a volatile memory and a non-volatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), and is used as an external cache. By way of example but not limitative description, many forms of RAMs may be used, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchlink dynamic random access memory (Synchlink DRAM, SLDRAM), and a direct Rambus random access memory (Direct Rambus RAM, DR RAM). It should be noted that, the memory in the systems and methods described in this specification includes but is not limited to these memories and any memory of another proper type.

It should be understood that, by way of example but not limitative description, for example, the memory in embodiments of this application may alternatively be a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synch link DRAM, SLDRAM), a direct Rambus random access memory (Direct Rambus RAM, DR RAM), or the like. In other words, the memory in embodiments of this application includes but is not limited to these memories and any memory of another proper type.

An embodiment of this application further provides a computer-readable storage medium, configured to store a computer program.

Optionally, the computer-readable storage medium may be applied to a network device in embodiments of this application, and the computer program causes a computer to execute corresponding procedures implemented by the network device in the methods in embodiments of this application. For brevity, details are not described herein again.

Optionally, the computer-readable storage medium may be applied to a terminal device in embodiments of this application, and the computer program causes a computer to execute corresponding procedures implemented by the terminal device in the methods in embodiments of this application. For brevity, details are not described herein again.

An embodiment of this application further provides a computer program product, including computer program instructions.

Optionally, the computer program product may be applied to a network device in embodiments of this application, and the computer program instructions cause a computer to execute corresponding procedures implemented by the network device in the methods in embodiments of this application. For brevity, details are not described herein again.

Optionally, the computer program product may be applied to a terminal device in embodiments of this application, and the computer program instructions cause a computer to execute corresponding procedures implemented by the terminal device in the methods in embodiments of this application. For brevity, details are not described herein again.

An embodiment of this application further provides a computer program.

Optionally, the computer program may be applied to a network device in embodiments of this application. When running on a computer, the computer program causes the computer to execute corresponding procedures implemented by the network device in the methods in embodiments of this application. For brevity, details are not described herein again.

Optionally, the computer program may be applied to a terminal device in embodiments of this application. When running on a computer, the computer program causes the computer to execute corresponding procedures implemented by the terminal device in the methods in embodiments of this application. For brevity, details are not described herein again.

A person of ordinary skill in the art may be aware that, units and algorithm steps in examples described in combination with embodiments disclosed in this specification can be implemented by electronic hardware or a combination of computer software and electronic hardware. Whether the functions are executed by hardware or software depends on particular applications and design constraints of the technical solutions. A person skilled in the art may use different methods to implement the described functions for each particular application, but it should not be considered that the implementation goes beyond the scope of this application.

Those skilled in the art may clearly understand that, for the purpose of convenient and brief description, for detailed working processes of the foregoing systems, apparatuses, and units, refer to the corresponding processes in the foregoing method embodiments, and details are not described herein again.

In the several embodiments provided in this application, it should be understood that the disclosed systems, apparatuses, and methods may be implemented in another manner. For example, the described apparatus embodiments are merely examples. For example, the module division is merely logical function division and may be other division in actual implementation. For example, a plurality of modules or components may be combined or integrated into another system, or some features may be ignored or not executed. In addition, the displayed or discussed mutual couplings or direct couplings or communication connections may be implemented by using some interfaces. The indirect couplings or communication connections between apparatuses or modules may be implemented in electronic, mechanical, or other forms.

The modules described as separate parts may be or may not be physically separate, and parts displayed as modules may be or may not be physical modules, and may be at one location, or may be distributed on a plurality of network modules. Some or all of the modules may be selected according to actual requirements to achieve the objectives of the solutions of embodiments. In addition, functional modules in embodiments of this application may be integrated into one processing module, or each of the modules may exist alone physically, or two or more modules may be integrated into one module.

When the functions are implemented in a form of a software functional module and sold or used as an independent product, the functions may be stored in a computer-readable storage medium. Based on such an understanding, the technical solutions of this application essentially, or the part contributing to the conventional technology, or some of the technical solutions may be implemented in a form of a software product. The computer software product is stored in a storage medium and includes several instructions for causing a computer device (which may be a personal computer, a server, a network device, or the like) to execute all or some of the steps of the methods described in embodiments of this application. The foregoing storage medium includes any medium that may store program code, such as a USB flash drive, a removable hard disk, a read-only memory (ROM), a random access memory (RAM), a magnetic disk, or an optical disk.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application should be subject to the protection scope of the claims.

What is claimed is:

1. A random access method, wherein the method comprises:
transmitting, by a terminal device, a first PRACH to a network device by using a first PRACH occasion; and
monitoring, by the terminal device, a first PDCCH by using a first RNTI, wherein the first PDCCH is used to schedule a PDSCH, and the PDSCH scheduled by the first PDCCH carries an RAR.

2. The method according to claim 1, wherein the method further comprises:
after receiving, by the terminal device, the first PDCCH or the PDSCH scheduled by the first PDCCH, determining, by the terminal device based on first indication information, whether the first PDCCH is a PDCCH for scheduling a first PDSCH; or, determining, by the terminal device based on first indication information, whether the PDSCH scheduled by the first PDCCH is a first PDSCH, wherein an RAR carried in the first PDSCH is an RAR corresponding to the first PRACH.

3. A terminal device, comprising a processor configured to perform operations of:
transmitting a first PRACH to a network device by using a first PRACH occasion; and
monitoring a first PDCCH by using a first RNTI, wherein the first PDCCH is used to schedule a PDSCH, and the PDSCH scheduled by the first PDCCH carries an RAR.

4. The terminal device according to claim 3, wherein the processor is further configured to perform operations of:
after receiving the first PDCCH or the PDSCH scheduled by the first PDCCH, determining, based on first indication information, whether the first PDCCH is a PDCCH for scheduling a first PDSCH; or, determining based on first indication information, whether the PDSCH scheduled by the first PDCCH is a first PDSCH, wherein an RAR carried in the first PDSCH is an RAR corresponding to the first PRACH.

5. The terminal device according to claim 4, wherein the first indication information is used to indicate at least one of following:
a system frame index corresponding to the first RNTI or a system frame index corresponding to the first PRACH occasion;
k least significant bits of a system frame index corresponding to the first RNTI or k least significant bits of a system frame index corresponding to the first PRACH occasion;
a system frame quantity value N corresponding to the first RNTI or a system frame quantity value N corresponding to the first PRACH occasion; or
a system frame index associated with the first RNTI in N system frames or a system frame index associated with the first PRACH occasion in N system frames;
wherein N is a positive integer greater than 1, and k is a positive integer greater than or equal to 1.

6. The terminal device according to claim 3, wherein the first RNTI is determined based on at least one of following:
a system frame index corresponding to the first PRACH occasion;
k least significant bits of a system frame index corresponding to the first PRACH occasion;
a system frame quantity value N corresponding to the first PRACH occasion; or
a system frame index associated with the first PRACH occasion in N system frames;
wherein N is a positive integer greater than 1, and k is a positive integer greater than or equal to 1.

7. The terminal device according to claim 6, wherein the first RNTI is determined based on a result of a modulo operation performed with the system frame index corresponding to the first PRACH occasion and the system frame quantity value N corresponding to the first PRACH occasion; or
the first RNTI is determined based on a result of a division operation performed with the system frame index corresponding to the first PRACH occasion and the system frame quantity value N corresponding to the first PRACH occasion; or
the first RNTI is determined based on the system frame index associated with the first PRACH occasion in the N system frames.

8. The terminal device according to claim 3, wherein the first PRACH occasion comprises M second PRACH occasions, the first RNTI is determined based on at least one second PRACH occasion in the M second PRACH occasions, and M is a positive integer greater than 1.

9. The terminal device according to claim 8, wherein the first RNTI is determined based on an RNTI corresponding to the at least one second PRACH occasion in the M second PRACH occasions.

10. The terminal device according to claim 8, wherein the first RNTI is an RNTI corresponding to the first second PRACH occasion in the M second PRACH occasions; or
the first RNTI is an RNTI corresponding to the last second PRACH occasion in the M second PRACH occasions.

11. The terminal device according to claim 8, wherein a PRACH format corresponding to the second PRACH occasion is at least one of following formats: 0, 1, 2, 3, A1, A2, A3, B1, B2, B3, B4, C0, or C2.

12. A network device, comprising a processor configured to perform operations of:
performing detection on a first PRACH by using a first PRACH occasion; and
after the first PRACH is detected by the network device, transmitting a first PDCCH by using a first RNTI, wherein the first PDCCH is used to schedule a PDSCH, and the PDSCH scheduled by the first PDCCH carries an RAR.

13. The network device according to claim 12, wherein the processor is further configured to perform operations of:
transmitting first indication information,
wherein the first indication information is used to indicate whether the first PDCCH is a PDCCH for scheduling a first PDSCH; or the first indication information is used to indicate whether the PDSCH scheduled by the first PDCCH is a first PDSCH,
wherein an RAR carried in the first PDSCH is an RAR corresponding to the first PRACH.

14. The network device according to claim 13, wherein the first indication information is used to indicate at least one of following:
a system frame index corresponding to the first RNTI or a system frame index corresponding to the first PRACH occasion;
k least significant bits of a system frame index corresponding to the first RNTI or k least significant bits of a system frame index corresponding to the first PRACH occasion;
a system frame quantity value N corresponding to the first RNTI or a system frame quantity value N corresponding to the first PRACH occasion; or
a system frame index associated with the first RNTI in N system frames or a system frame index associated with the first PRACH occasion in N system frames;
wherein N is a positive integer greater than 1, and k is a positive integer greater than or equal to 1.

15. The network device according to claim 12, wherein the first RNTI is determined based on at least one of following:
a system frame index corresponding to the first PRACH occasion;
k least significant bits of a system frame index corresponding to the first PRACH occasion;
a system frame quantity value N corresponding to the first PRACH occasion; or
a system frame index associated with the first PRACH occasion in N system frames;
wherein N is a positive integer greater than 1, and k is a positive integer greater than or equal to 1.

16. The network device according to claim 14, wherein the first RNTI is determined based on a result of a modulo operation performed with the system frame index corresponding to the first PRACH occasion and the system frame quantity value N corresponding to the first PRACH occasion; or
the first RNTI is determined based on a result of a division operation performed with the system frame index corresponding to the first PRACH occasion and the system frame quantity value N corresponding to the first PRACH occasion; or
the first RNTI is determined based on the system frame index associated with the first PRACH occasion in the N system frames.

17. The network device according to claim 12, wherein the first PRACH occasion comprises M second PRACH occasions, the first RNTI is determined based on at least one second PRACH occasion in the M second PRACH occasions, and M is a positive integer greater than 1.

18. The network device according to claim 17, wherein the first RNTI is determined based on an RNTI corresponding to the at least one second PRACH occasion in the M second PRACH occasions.

19. The network device according to claim 17, wherein the first RNTI is an RNTI corresponding to the first second PRACH occasion in the M second PRACH occasions; or
the first RNTI is an RNTI corresponding to the last second PRACH occasion in the M second PRACH occasions.

20. The network device according to claim 17, wherein a PRACH format corresponding to the second PRACH occasion is at least one of following formats: 0, 1, 2, 3, A1, A2, A3, B1, B2, B3, B4, C0, or C2.
